(19) United States
(12) Patent Application Publication
(10) Pub. No.: US 2002/0169771 A1
(43) Pub. Date: Nov. 14, 2002

(54) System & method for facilitating knowledge management

(76) Inventors: Kenneth L. Melmon, Woodside, CA (US); Thomas C. Rindfleisch, Palo Alto, CA (US); Ching-Feng Tsai, Palo Alto, CA (US); Howard R. Strasberg, Menlo Park, CA (US)

Correspondence Address: GARY CARY WARE & FREIDENRICH LLP, 1755 EMBARCADERO ROAD, PALO ALTO, CA, 94303-3340, US

(21) Appl. No.: 09/852,460

(22) Filed: May 9, 2001

(51) Int. Cl. G06F 7/00

(52) U.S. Cl. 707/5

(57) ABSTRACT

The present invention affords an information system that is simple to use, can be queried in a user-friendly manner, is capable of searching multiple resources in parallel to effect an efficient search, presents diverse information in an easy-to-comprehend format, and allows rapid and intuitive navigation among high-quality contextual information. The invention allows a user to enter a simple query, search all available resources in parallel (or alternatively select only those resources of interest), and navigate among the search results using an intuitive user-interface to develop an action plan based on the resulting information. As a result, a user takes information from several sources and turns that information into action-oriented knowledge that can be applied to solve a particular problem. The amount of information available is secondary to the quality and relevance of the information and how readily it can be synthesized as knowledge by the user. The invention may also afford multiple educational aspects where a user can attain credit for the review and application of the information retrieved and where integration of the system with an electronic medical record provides information on the impact of learning on order entry and clinical outcomes.

The present invention relates to knowledge systems, and more particularly, to a system and method for facilitating the transformation of stand alone information to useful and applied knowledge management.

### BACKGROUND OF THE INVENTION

Knowledge management for decision-making, knowledge sharing, and continuing education is a central concern of professionals and enterprises in today's knowledge centered economy. This is especially true for medicine, where keeping pace with the rapid expansion of medical knowledge and applying it accurately in clinical practice are nearly impossible using traditional methods. Each year, the National Institute of Health spends approximately $15 billion on new biomedical research and nearly 500,000 peer-reviewed articles are published, indexed, and added to the 11 million articles already accumulated in the National Library of Medicine's (NLM's) MEDLINE system.

Further, the pharmaceutical industry introduces about 40 new drugs each year. It is well documented that practicing physicians have serious unmet informational needs. Questions often arise during patient care, and most of these questions are not answered, even though answers frequently exist in published resources. Medical knowledge is simply too voluminous and is changing too rapidly for physicians to manage and learn all they need to know without help.

Many contemporary medical information products have sought to make information and reference resources of various kinds available online. Often, these resources are limited to those available from particular publishers. Despite these first steps, such information services still do not allow physicians to answer clinical questions efficiently and confidently. Each has its own idiosyncratic interface and a physician faced with a problem requiring coordinated information from textbooks, literature, guidelines, drug databases, or formularies, and local procedures must know where to find and how to query these various resources in order to solve their problem. Health science libraries, charged with licensing rich information resources for health care and educational institutions, are frustrated by being able to do little more than put a collection of stand-alone digital “books and journals” on the web “shelf” for users, with little ability to integrate these resources in seamless ways for end users. In addition, much of the information found on the open Internet is poorly organized, difficult to locate, of variable quality and authority and not at all well integrated with other related clinical information.

Information needs for continuing medical education (CME) requirements (or other similar educational needs) are just as important as those occurring during an encounter with a patient. State licensing boards have established requirements that must be met for physicians to maintain licensure. Unfortunately, CME is frequently no more successful in meeting physicians' long-term educational needs than are current information technologies in meeting decision-support needs.

Traditional CME methods have been largely didactic in nature, often structured around conferences or fixed lessons, and divorced from medical practice. The effectiveness of CME is inherently compromised because experts choose topics that they presume, but are not certain, because they cannot consult with their prospective students, should be important to the intended audience. The most effective CME methods use practice-enabling or reinforcing methods that focus not on the cognitive, but the procedural elements of the practice of medicine. Much of the failure to link CME closely with the medical practice has resulted from the ineffectiveness of earlier information systems in the physician's workplace and the regulatory decision to not allow self-initiated learning for the majority of physicians' Category 1 CME credit (the highest category of credit awarded by the ACCME, the Accreditation Council for Continuing Medical Education, that is required for state licensure). A “practice-learning” model of CME has been approved by the ACCME where CME becomes a means of improving patient outcomes through enhanced physician performance and is no longer an activity that is separate in terms of time and place from patient care. There is thus a need for a system that is approved by ACCME to award such Category 1 CME credits, based on demonstrated learning in patient care settings. There is also a need for a system and method that facilitates knowledge management and in-context continuous learning.

Conventional systems have sought to address these needs, yet have been unsuccessful. U.S. Pat. No. 4,895,518 entitled “Computerized Diagnostic Reasoning Evaluation System” describes a response manager for nursing training. However, the system lacks independent literature search capabilities and response generation techniques. U.S. Pat. No. 5,517,405 entitled “Expert System for Providing Interactive Assistance in Solving Problems such as Health Care Management” describes an expert system intended to guide a user from a healthcare problem to recommended solutions. The system includes two modes, a novice mode, in which the system plays an active role (similar to artificial intelligence decision-support tools), and an expert mode in which the user has more latitude to search for and apply information to solve the problem. However, the questions used to recommend solutions are pre-coded in the system.

U.S. Pat. No. 5,727,951 entitled “Relationship-based Computer-aided-educational System” uses a domain ontology to help students identify gaps in their knowledge and a lesson generator to facilitate learning in identified gap areas. The system includes assessment feedback capabilities, but uses a structured lesson environment. U.S. Pat. No. 5,779,486 entitled “Methods and Apparatus to Assess and Enhance a Student's Understanding in a Subject” describes generating test questions as a way to guide student learning of a subject area. However, the system is quite autonomous in finding and resolving knowledge conflicts within a limited representation of domain information.

Another form of knowledge transmission has been computer-based training. These systems have typically been designed for individualized self-study by following a system-controlled sequence of presenting content, testing knowledge levels, suggesting remedial activity, and repeating lessons where necessary. A clear disadvantage, however, is that the flat-file, sequential physical structure and design methodology creates certain limitations, such as precluding any ability to spontaneously address the need for individual information or differences in learning style needs (i.e., the same content is presented to everyone, whether needed or not). Also, traditional course development methods are so tedious and time-consuming that course content often is obsolete by the time it has been developed.

Automated problem-solving systems generally fall into two different types. The inexpensive, simpler type uses a tree structure to narrow down a problem to the point whereby the system makes a specific recommendation to the user. While this provides an advantage of quick assistance in the solution of known, simple problems, the technique is inherently system-driven rather than being guided by the individual, which provides clear disadvantages to users in that it enables only limited learning capability as the data analysis and decision-making is automated, and that the value of the system is limited to the conditions and problems known to the programmer, not the student, at the time of program construction. The other type, known as expert systems, perform the same functions with the same, but more severe, attendant problems because of its increased complexity. The heavy integration of complex logic with rules for professional application of complex knowledge is very difficult if not impossible to program. It requires the programmer to be as skilled in the expert knowledge and its application as in programming, and for all possible conditions and variables of complex problems, to be predefined with an action related to each. Thus, there is a real need for a system that facilitates complex knowledge management in such a way that overcomes the above disadvantages and adapts to a user's environment and needs, in effect facilitating the application of the user's own intelligence and professional skills. It is to these ends that the present invention is directed.

### SUMMARY OF THE INVENTION

The present invention affords an information system that is simple to use, can be queried in a user-friendly manner, is capable of searching multiple resources in parallel to effect an efficient search, presents diverse information in an easy-to-comprehend format, and allows rapid and intuitive navigation among high-quality contextual information. The invention allows a user to enter a simple query, search all available resources in parallel (or alternatively select only those resources of interest), and navigate among the search results using an intuitive user-interface to develop an action plan based on the resulting information. As a result, a user takes information from several sources and turns that information into action-oriented knowledge that can be applied to solve a particular problem. The amount of information available is secondary to the quality and relevance of the information and how readily it can be synthesized as knowledge by the user. The invention may also afford an educational aspect where a user can attain professional credit for the review and application of the knowledge developed.

In an aspect, the invention affords a system for facilitating transfer of information into practically applicable knowledge. The system comprises a query and information retrieval subsystem for accessing one or more databases and retrieving one or more documents from the databases that satisfy a particular query, a search interface manager for mapping the query to a particular search syntax for a particular database, and a log recording sub-system for recording activity relating to a search. Local and remote databases may be searched, and the databases can include proprietary databases and non-proprietary databases. Documents stored in the databases include content elements including any of text, diagrams, images, audio clips, video clips, and direct collaborative links (among others).

Preferably, a document is represented by an object structure encoding content of the document, a description of the document, any relationship among additional documents, and structure of the document. The content may also be selectively marked with XML tags to indicate the internal context of the content and to indicate relationships among content sources, where the XML tags are used for searching and retrieving the content, and permit the adaptation of the content to be displayed on any type of output display using XSL. Alternatively, the content may be selectively marked with HTML tags to indicate the internal context of the content and to indicate relationships among content sources.

The databases store resources including any of text books, bibliographic resources and journals or user provided databases (among others), that are searchable by the query and information retrieval sub-system. Advantageously, the system may be customized for a particular field of endeavor. For example, in an embodiment of the system tailored to the general medical field, the databases may include searchable resources including any of text books, bibliographic resources, journals, drug databases, national or local clinical guidelines, evidence-based medicine resources, patient information, drug formularies, policy information, procedure information, and educational information (among others).

An external interface module permits the interfacing of the system with a particular external server hosting a respective non-proprietary database. The interfacing can be provided via the Internet using the HTTP protocol. A proprietary interface module permits the interfacing of the system with a particular proprietary information system associated with a respective proprietary database. An API interface module translates general requests from the proprietary interface module to requests that are recognizable by the proprietary information system for accessing the proprietary database and for performing a search operation in accordance with the query to retrieve information from the proprietary database satisfying the particular query.

The local databases store resource information native to the system, and such resources are preferably stored using structured metadata descriptors to improve retrieval performance, facilitate an ontology-based indexing scheme, and to allow searching of non-text content such as images, streaming audio clips, or streaming video clips. A native search module permits the searching of one or more of the local databases to retrieve information satisfying the particular query. In an embodiment, the metadata descriptor structure includes a source portion for indicating a resource to which a particular document belongs, an object ID portion for tracking and indicating an identifier for a particular document, a document type portion for indicating a type of document, one or more field attributes for indicating information about a particular document, and a content object portion for indicating a type of object to associate with a particular document.

In response to a query request including one or more query terms, a search operation is performed in accordance with the query terms by referencing an object index file to locate a respective object ID corresponding to one or more documents containing at least one of the query terms or concepts represented by the query terms. Preferably, a search operation is performed on each database in parallel, and the retrieved documents are presented in accordance with a dynamic ontological structure utilizing semantic relationships among document classes and dynamically linked permitting rapid review of those documents most relevant to the particular query.

The log recording system comprises a user log and notebook function which permits a user to assess the value of particular content resources, and in actively managing and organizing retrieved information. The log recording system generates one or more log entries in the user log indicating information relating to the search. Each log entry may be hyperlinked permitting reconstruction of the associated search by selecting an appropriate log entry. The notebook permits the user to select and store one or more log entries deemed important by the user in a user-defined hierarchical folder structure and to record comments relating to the each such notebook entry and to share search, query, CME, or other notebook information with additional users.

The system may also include an educational module for permitting self-initiated learning related to subject matter of the query. Advantageously, the educational module can be customized for a particular field of endeavor. For example, in an embodiment, the educational module permits Continued Medical Education learning. In such an embodiment, one or more questions may be presented that are related to subject matter of the retrieved documents, and responses to those questions may be submitted for processing of the validity of learning by the student-user. In accordance with an audit of the responses, educational credit may be awarded if adequate evidence of learning is apparent.

In another aspect, the invention provides a metadata descriptor structure for creating and facilitating a structured ontology-based indexing scheme within a database including one or more documents. The structure comprises a source portion for indicating a resource to which a particular document belongs, an object ID portion for tracking and indicating an identifier for a particular document, a document type portion for indicating a type of document, one or more field attributes for indicating information about a particular document, and a content object portion for indicating a type of object to associate with a particular document.

In still another aspect, the invention affords a method for enabling self-initiated learning. The method comprises the steps of identifying a particular problem to be solved, performing an integrated search for a solution to the problem by automatically generating a query related to the problem and submitting the query using a query and information retrieval sub-system which permits accessing one or more databases and retrieving one or more documents from the databases that satisfy the query such that a search interface manager maps the query into a particular search syntax for a particular database, reviewing the resulting information to identify a solution to the problem, and requesting educational credit for the experience by responding to one or more questions that are related to the retrieved information.

In yet another aspect, the invention affords a method for enabling self-initiated learning by an individual. The method comprises the steps of performing an integrated search using a system for facilitating knowledge management by entering a query relating to a particular issue of interest, parsing the query into a first set of one or more related query terms and performing a search of a database of one or more pregenerated questions that relate to the issue of interest, electing one or more of the questions from the database for generating a respective response to each question based on the knowledge gleaned from performing the integrated search, for each response that is incorrect, parsing the answer into a second set of one or more related query terms and performing a search of resources in which answers to the respective question can be determined, and determining an appropriate amount of credit relating to the query that is to be assigned to the individual.

In another aspect, the invention affords a method for enabling self-initiated learning by an individual, comprising the steps of analyzing research patterns of the individual over a predetermined period of time, identifying common subject matter relating to the research pattern of the individual, referencing a matrix of subjects that relate to or are part of the identified subject matter to determine a density factor of the interest of the individual in the related subjects, determining a deficiency in the research pattern of the individual, the deficiency relating to a particular subject area, prompting the individual of the availability of an associated mini-course relating to the subject area, if the individual accepts the mini-course, automatically generating one or more query terms relating to the subject area, performing an integrated search using a system for facilitating knowledge management for resources relating to the query terms, and reviewing the resources to supplement the knowledge of the individual in the subject area.

### BRIEF DESCRIPTION OF THE DRAWINGS

FIG. 1 is a block diagram illustrating the general architecture of the invention;

FIG. 2 is an exemplary diagram of a metadata description structure for representing documents within the system;

FIG. 3A is an exemplary webpage representation which illustrates various resource categories that can be searched using the invention;

FIG. 3B is an exemplary webpage representation which illustrates a summary of “hits” located in the resource categories shown in FIG. 3A after performing a search in accordance with the user's query;

FIG. 3C is an exemplary webpage representation which illustrates the search results relating to textbook resources;

FIG. 3D is an exemplary webpage representation which illustrates hits in a textbook that is presented in a particular ontological structure to indicate relevant information;

FIG. 3E is an exemplary webpage representation which illustrates a particular document from the ontological structure of FIG. 3D;

FIG. 3F is an exemplary webpage representation which illustrates a document reference associated with a selected hyperlink from the document shown in FIG. 3E;

FIG. 3G is an exemplary webpage representation which illustrates the document referenced in FIG. 3F;

FIG. 3H is an exemplary webpage representation which illustrates the search results relating to journal articles;

FIG. 3I is an exemplary webpage representation which illustrates an abstract of a particular one of the relevant journal articles identified in FIG. 3H;

FIG. 3J is an exemplary webpage representation which illustrates the full-text of the journal article shown in FIG. 3I;

FIG. 3K is an exemplary webpage representation which illustrates the search results relating to drug information;

FIG. 3L is an exemplary webpage representation which illustrates a particular reference selected from the drug information results indicated in FIG. 3K;

FIG. 3M is an exemplary webpage representation which illustrates the search results relating to patient information;

FIG. 4A is an exemplary representation of a log record relating to a search performed by a user indicating various log entries which identify various resources reviewed by the user;

FIG. 4B is an exemplary representation of a notebook with a set of user-definable folders for categorizing information and a record relating to a search performed by a user and stored in one of the folders with user annotations;

FIG. 5A is a flowchart illustrating how a user can use the invention for both practical as well as educational means;

FIG. 5B is a flowchart illustrating another method of how a user can use the invention for both practical as well as educational means; and

FIG. 5C is a flowchart illustrating still another method of how a user can use the invention for educational means.

### DETAILED DESCRIPTION OF THE PREFERRED EMBODIMENT

The architecture of the system enables the integration of diverse information resources in support of knowledge-intensive end-users. While the invention is described in the context of a system for facilitating the search and retrieval of medical information, those skilled in the art recognize that the invention has a greater applicability and can be used for other fields as well, such as engineering, architecture, business, law, education, or corporate enterprise intranet information services designed to facilitate the sharing of specialized expertise or learning opportunities (among others). The present invention is not intended to be limited to the embodiment described herein.

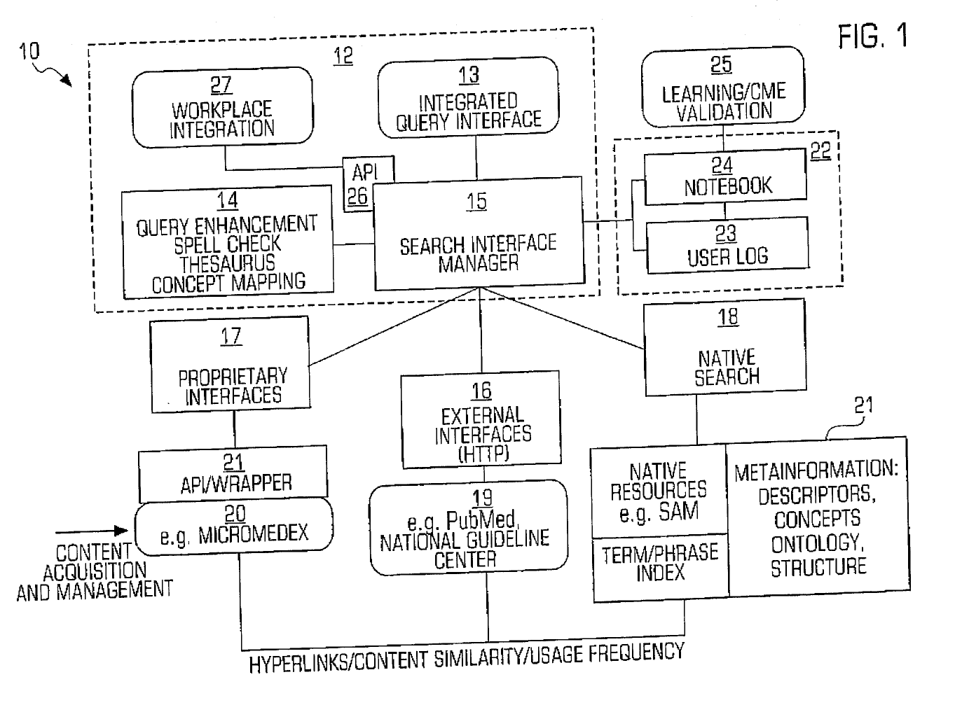

FIG. 1 is a block diagram illustrating the general architecture of the system 10. Particular features of the system 10 include the seamless integration of diverse information resources, including formal resources (i.e., books and journals), and local institutional information, a simple search entry and refinement interface, a powerful ontology-based navigation tool, a Web-enabled user log and notebook structure, a user-initiated context based education engine, a configurable information environment that is based on user needs, and a representation of structured documents using a particular protocol, such as XML markup and metadata, or other similar language protocol. These and other features of the system will be described in more detail below.

The system 10 includes an integrated query and information retrieval sub-system 12. Such a system may, in the context of the medical field, for example, meet the medical knowledge needs of primary care physicians through an intuitive and unified web-based interface. Content may be integrated in the form of any medium, such as text, diagrams, images, streaming audio clips, streaming video clips, direct collaborative links, and features to allow editing and submission of resources in any (word, image, video, sound, etc.) format. For example, in a system for the medical field, resources may include text books (including drawings, figures, and equations), bibliographic resources, on-line journals, drug databases, national clinical guidelines, and evidence-based medicine resources, patient information, and local enterprise information, such as drug formularies, policies and procedures, or teaching modules. In embodiments of the system tailored to other fields, other content resources may be integrated/supplemented.

Advantageously, a set of fully integrated information management services may be used to allow a user to enter query terms into the query and information retrieval sub-system 12 using a single set of retrieval skills and which permits simultaneous searching through multiple knowledge resources. This will be described in more detail below.

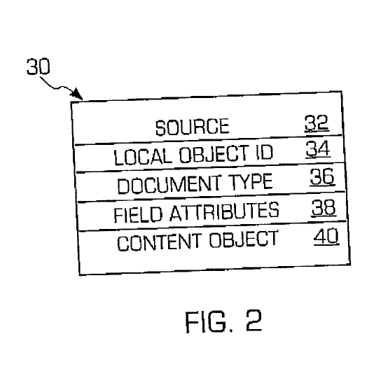

Preferably, each document resource is represented by a distinct object structure, which encodes the content, description, interrelationship, and structure of the document. Resources indexed directly within the system 10 may be stored with structured metadata descriptors to improve retrieval performance, to facilitate ontology-based navigation to topics of interest, and to allow searching of non-text content such as images, streaming audio clips, or streaming video clips. For example, a document may have the metadata descriptor structure 30 shown in FIG. 2, which records the locations and relationships between document sections.

As shown in FIG. 2, the descriptor structure 30 may include a source portion 32 for indicating the resource to which the document belongs, for example, in a system tailored to the medical field, a particular resource could be a Primary Care Teaching Module. The structure 30 may also include a local object ID portion 34 for tracking and indicating an internal identifier for a particular document. An exemplary local object ID may be 40005002.html. A document type portion 36 for indicating the type of document, such as an HTML object for example, may also be included. Other metadata that may be included in the structure 30 may include field attributes 38 that indicate information about the document such as author, title, date, etc., and a content object portion 40 for indicating the type of object to associate with the resource, for example, an HTML document object.

Each document is given a unique document ID number which provides an efficient shorthand for linking and referring to the object containing the document. When a user performs a query as will be described below, the system 10 preferably searches for the user's entered search terms in object index files and returns the document ID number corresponding to any document (object) containing those search terms. Another benefit of using document ID numbers is the system's ability to record exactly which user accesses particular documents, and at what time those documents are accessed, based, for example, on a user ID and password authentication mechanism. Since every object retrieved by the user has a unique ID number, the system 10 can automatically log these numbers along with the time and date that the object was accessed. This technique can be accomplished using principles that are well known in the art.

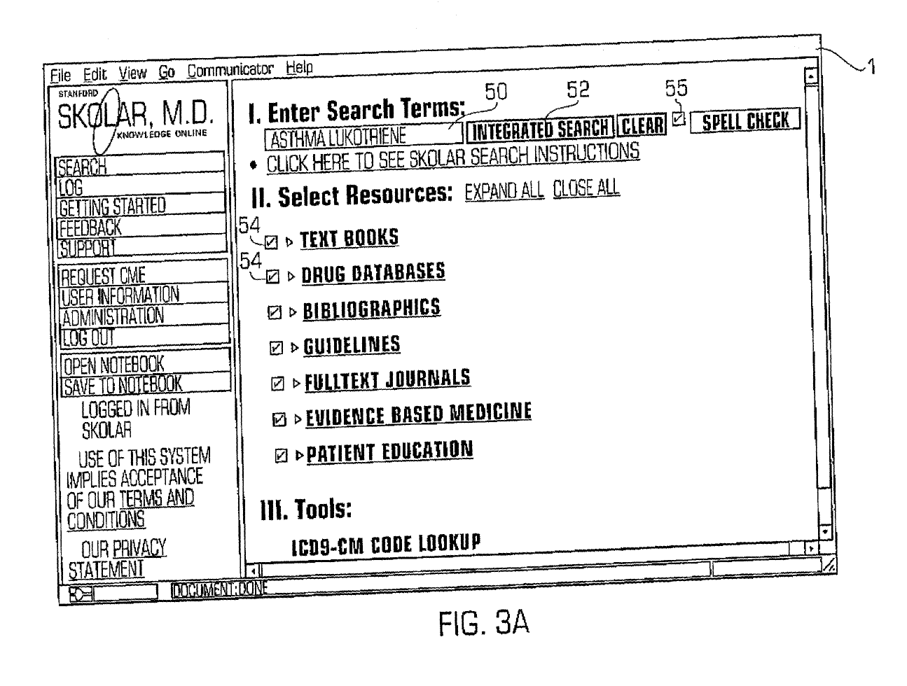

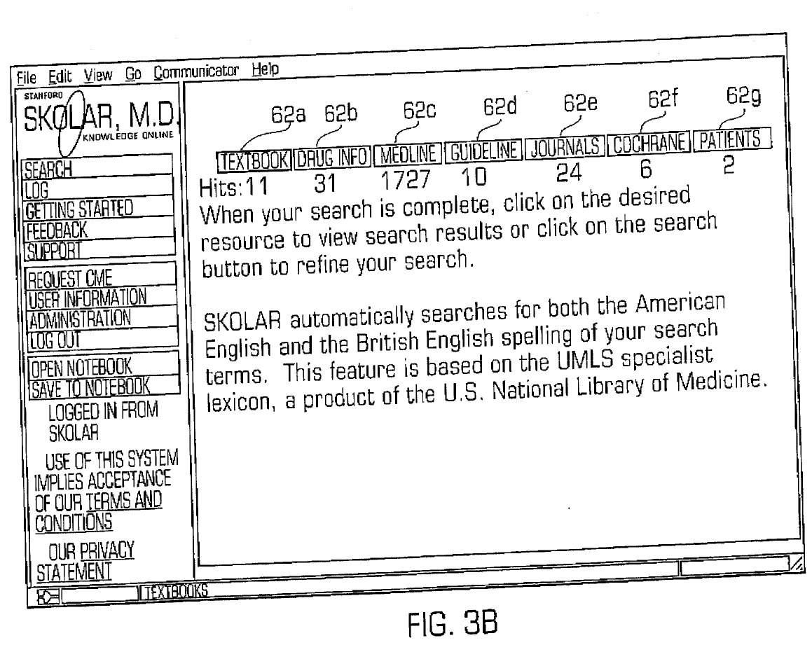

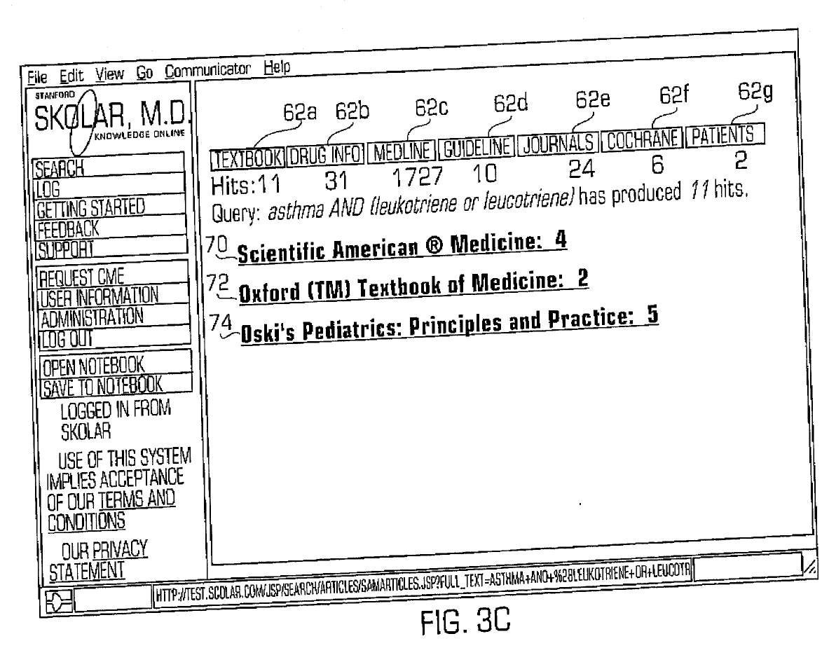

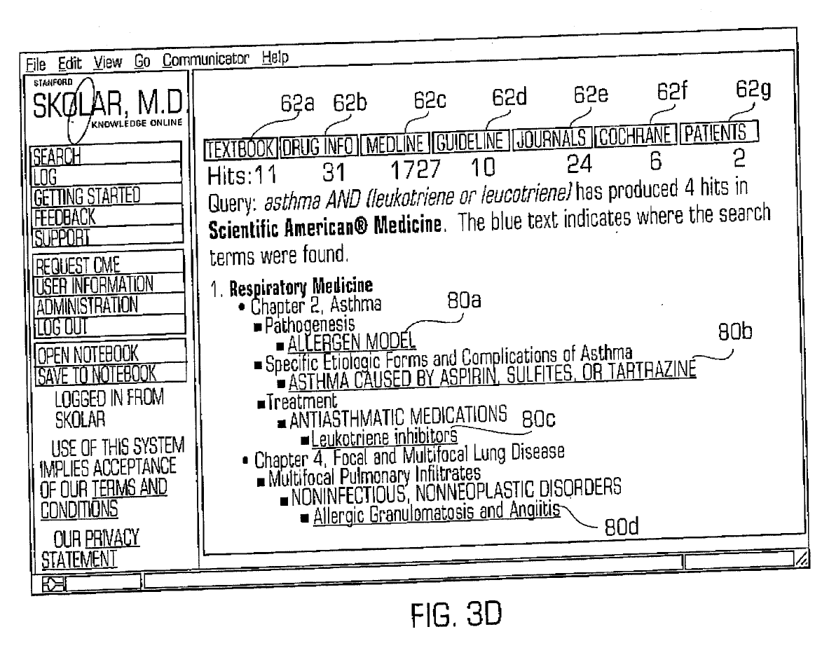

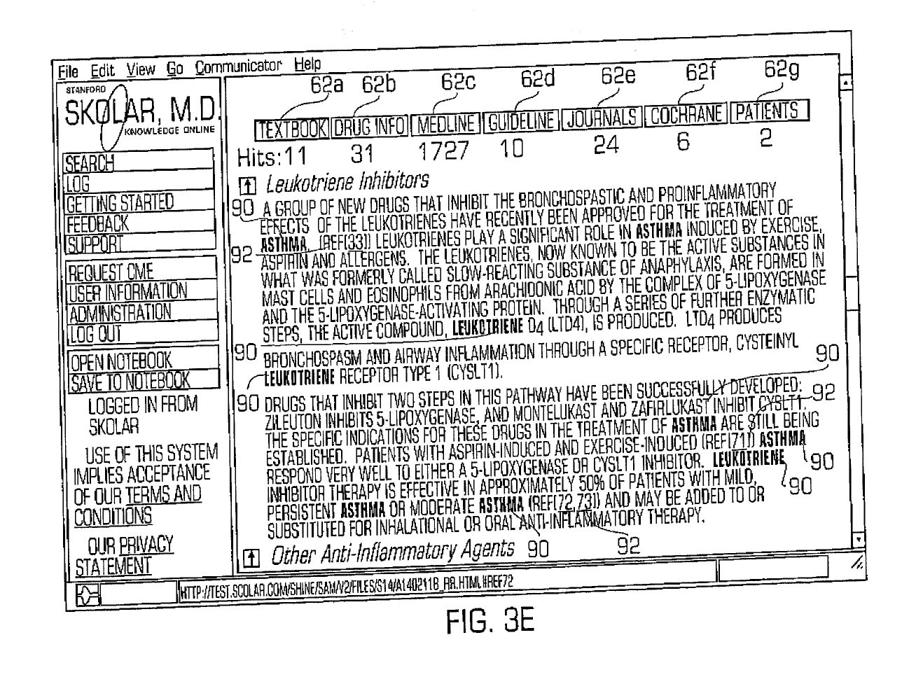

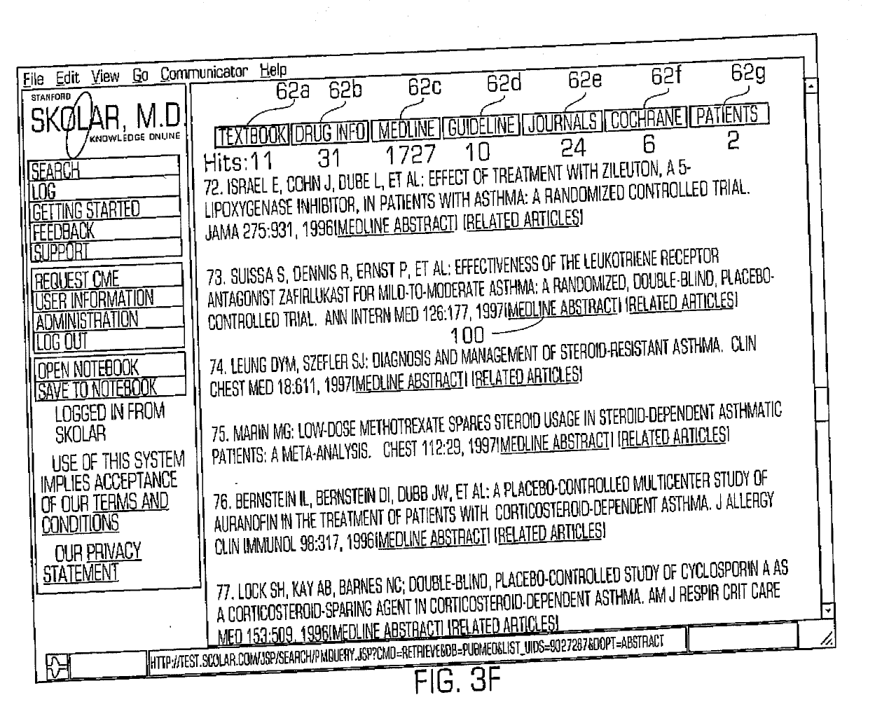

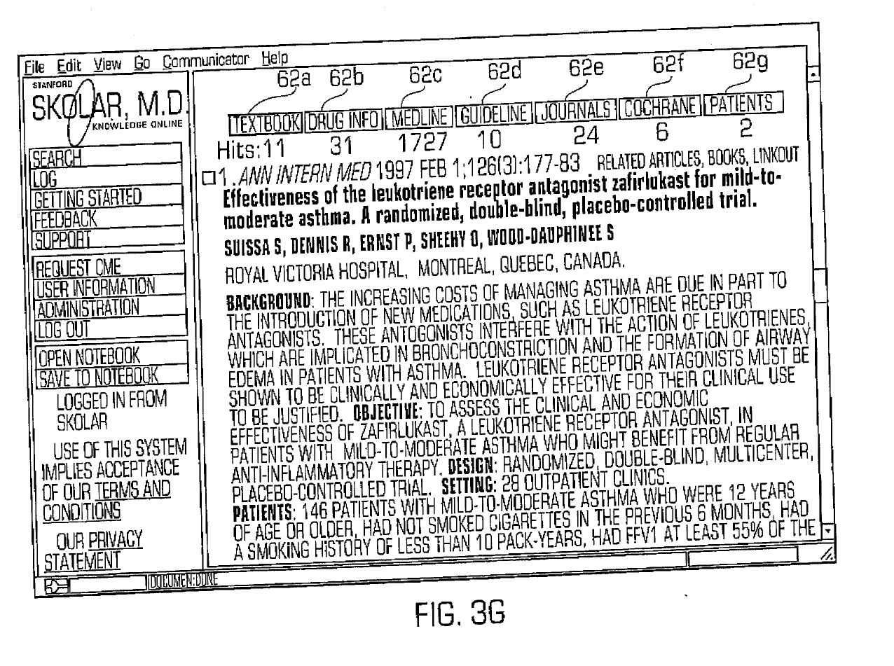

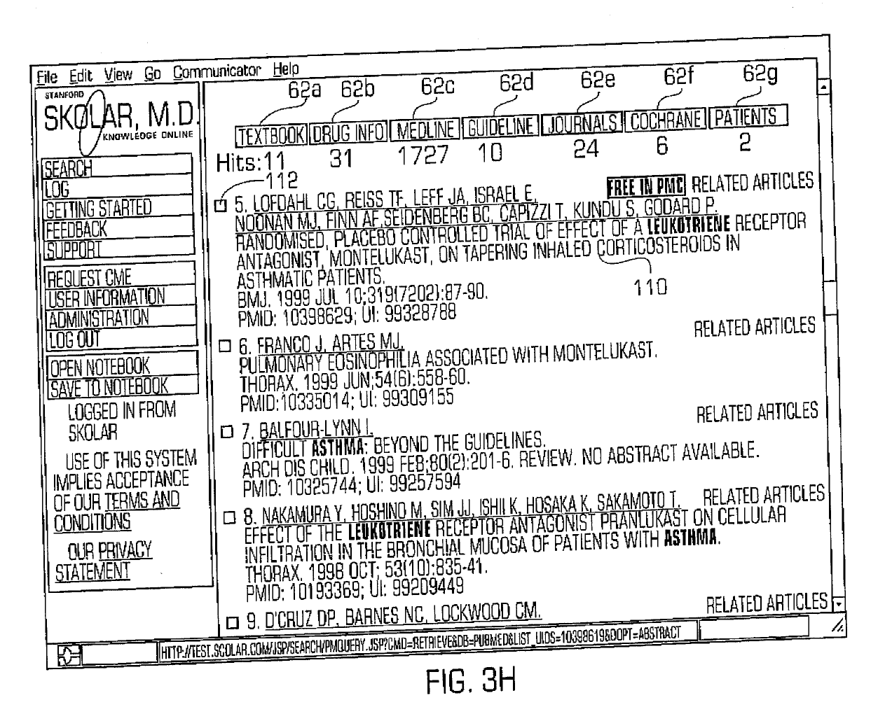

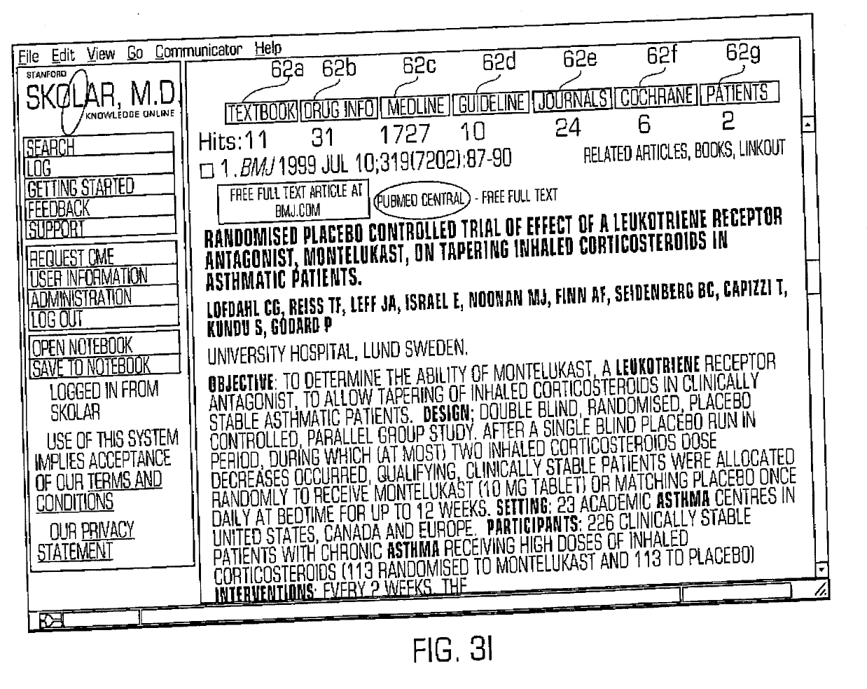

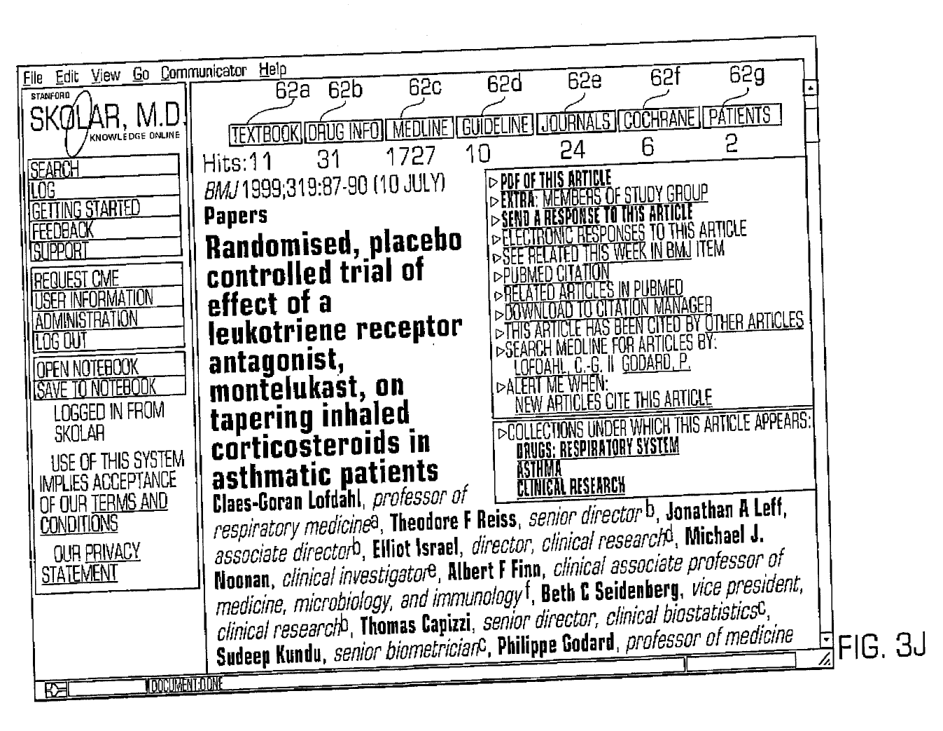

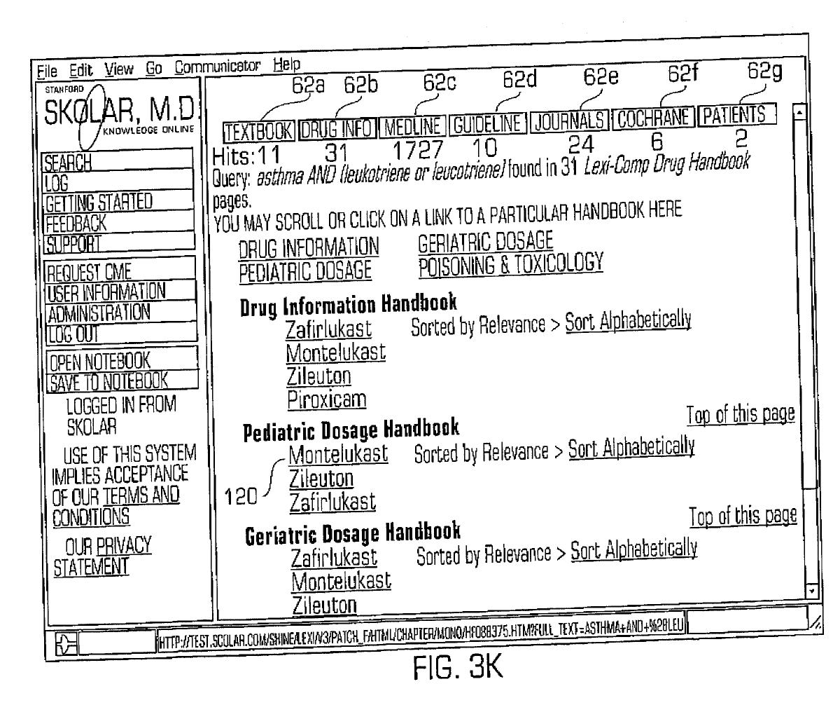

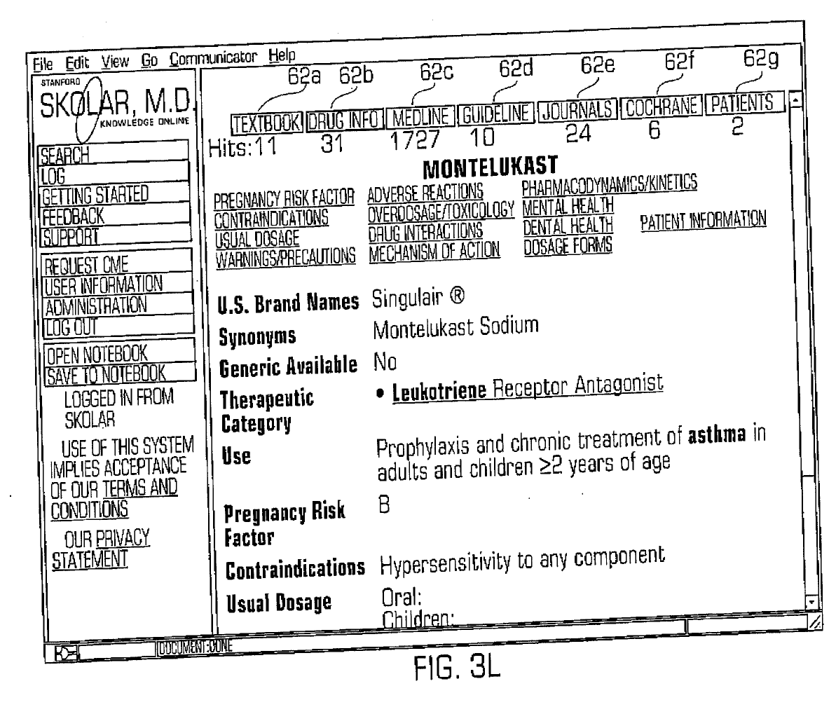

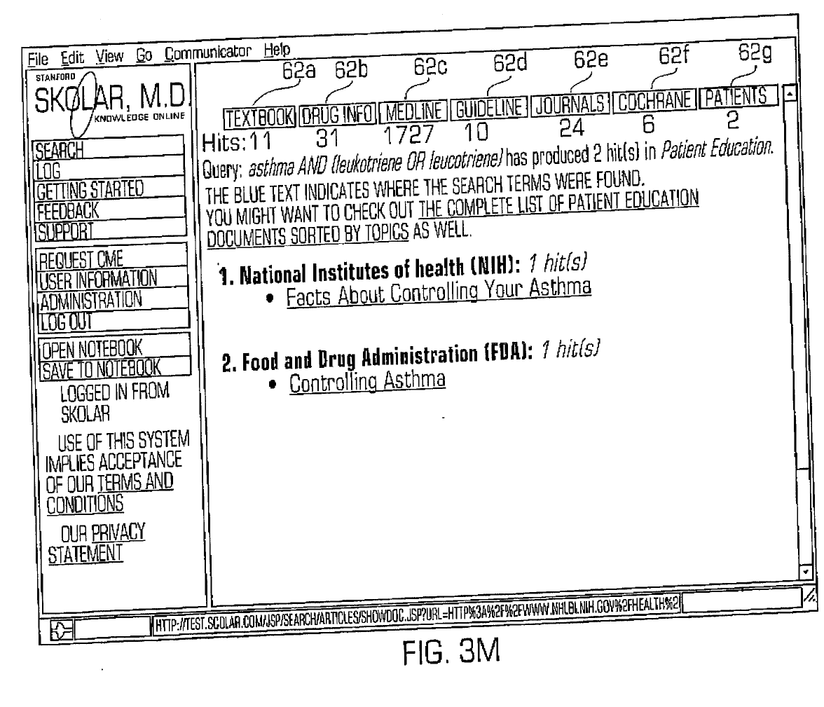

Advantageously, any content can be handled by the system by representing its content and descriptive (meta) information as system object structures. Objects can be text documents, graphic images, audio segments, streaming video segments, and interactive teaching modules (among other types of resources). There is no limit to the type of resources available to users using the system. In addition, by displaying search result totals for clusters of objects of various types, as will be described below, the user can quickly decide what information is needed and relevant. Preferably, a user query returns a collection of keyword hits, which may be presented as a logical array of hits in related information clusters (as shown in FIG. 3B, described below). This can be accomplished, for example, by organizing document ID's so that related ID's can be accessed readily.

The invention preferably utilizes XML (eXtended Markup Language) tags, as defined within appropriate DTD (Document Type Definition) frameworks, to specifically mark its content so that the system knows the internal context of a content element and when and how one object is related to another; however, other techniques may be used without departing from the invention. XML offers better capability than HTML, for example (although HTML can be used effectively), in that XML allows any tag to be placed within a given content versus only the specified set of display-oriented tags in HTML. Thus, XML-marked content can carry tags specifically describing the context and conceptual significance of content elements. Such XML tags can thus be used to search content more effectively so that the information retrieved is highly relevant to the user's input query. Additionally, since XML tags are free from any pre-defined constraint (as in HTML), XML-marked content can be easily adapted to fit any kind of display, using XSL (the eXtended Style-sheet Language). This allows the invention to be deployed on devices from desktop computers to mobile personal digital assistants and the like.

Returning to FIG. 1, the information query and retrieval sub-system 12 may include a number of component modules. An integrated query interface module 13 may permit a user accessing the system via the Internet, or other communications network, to interact with the system 10, for example, by entering and submitting a keyword (or other form) query for searching the resources associated with the system 10.

In practice, a user accessing the Internet, or other communications network, may log onto a website associated with the system 10 (which is served by a particular server within the network). The website permits remote user access to the system 10, and presents the user with a unique user-interface 13 for the integrated query and information retrieval sub-system 12 from which the user can interact with the system. FIG. 3A is an exemplary representation of such a user-interface 13 that may be presented to the user.

Upon accessing the user-interface 13, as discussed above, the user may enter a query in a search field box 50, for example, by typing various words or phrases into the field box 50 that relate in some manner to the particular information of interest to the user. Advantageously, the user-interface 13 is accessible through any Internet connection (or other communications network means), and preferably utilizes conventional web browsers, such as Netscape Navigator, or Microsoft Internet Explorer to present its contents to the user.

A user can elect the resources desired to be searched, for example, by selecting a checkbox (or other selecting means) 54 associated with a resource type. A user can also elect whether to perform a spell check operation of the query terms during processing by selecting a checkbox (or other selecting means) 55 accordingly. In FIG. 3A, which illustrates resources tailored to an embodiment of the system for the medical field, the various resources available include textbooks, drug databases, bibliographies, guidelines, full text journals, evidence based medicine, and patient education. These resources are merely a sample of those available with the system, and are not intended to be limiting. Other embodiments of the system may include different references. The query, once submitted, for example by clicking on an “Integrated Search” button 52 or causing a properly formatted HTTP request to be sent to the system or otherwise submitting the query for processing, may be processed with appropriate spelling correction, and with user-controllable query-refinement techniques which will be described in more detail.

Referring again to FIG. 1, to accommodate the differences in interface and structure of various resources, the user-supplied query may be “mapped” by a search interface manager 15 into the particular search syntax for each resource, and transmitted concurrently to search all selected resources (or those resources of particular interest to the user). The search interface manager 15 may break the user's input query into its component terms and phrases, which may be subsequently improved by a query enhancement module 14. Terms and phrases are compared against a domain dictionary to detect possible spelling errors and the like. Upon detecting a possible spelling error, the user may be offered suggestions for corrected spellings and the opportunity to change the query. The corrected query terms and phrases from the query enhancement module 14 are then composed into resource-specific query strings for each database to be searched by the search interface manager 15, based on the query syntax requirements and limitations of each resource. Correct Boolean expressions may be constructed automatically by substituting default AND operators, and including disjunctive word variant and synonym expansions to cover alternative spellings (such as American, Canadian, and British spellings, for example), common term alternatives (such as “montelukast” and “Singulair”), common acronyms (such as “dvt” and “deep venous thrombosis”), and other qualified variants. These query expansions and syntax rules use a database relation of keywords and mappings derived from reviewed sources, such as dictionaries, drug databases, the NLM UMLS (Unified Medical Language System), and expert opinion, and procedural syntax generation modules. The search interface manager 15 forwards, preferably in parallel, corrected and enhanced query strings in appropriate syntaxes to each resource and database for searching.

Depending on the implementation of the system 10, some resources may be searched directly within the system 10, while others may be remotely searched, for example, by enabling Internet interfaces to external servers or otherwise interfacing with these external servers. This integrated search capability greatly increases the usability of the system. Different interfaces can be utilized. For example, an external interface module 16 enables the system 10 to be integrated with various external servers 19 that host various information systems, such as PubMed, the National Guideline Center, and other types of information systems. Preferably, such information systems are accessible remotely, for example, via the Internet, using traditional communication protocols such as HTTP and the like. Accordingly, the external interface module 16 enables remote access of such servers 19. The search interface manager 15 incorporates individual search and interface protocol classes for each target database or resource to be searched and executes these classes according to whether the user has selected the corresponding database or resource to be included in the search. These search and interface protocol classes embody the query syntax rules, interface protocol rules, and result parsing rules for successfully searching and analyzing the results for each target database or resource.

Proprietary interface modules 17 can also be utilized by the system 10 to enable the system to interface with various proprietary information systems 20, such as Micromedex, for example. To properly interface with such proprietary information systems 20, the system 10 may utilize an Application Programming Interface (API) module 21 which translates general requests from the proprietary interface module 17 to requests that are recognizable by particular proprietary information systems 20.

The API 21 preferably implements an HTTP protocol between the proprietary interface 17 and the remote system wrapper to submit a search, to retrieve the search results, to request full-text content, and to retrieve full-text content results. The wrapper communicates with the database resource 20 according to proprietary interface conventions established by the resource provider.

A native search module 18 permits the system 10 to search its own content in response to a user-initiated query. As discussed above, the system 10 may incorporate a large amount of searchable content located in various native resources. The content may be searchable using a term/phrase index or concept(s) or other similar types of searching tools to locate resources of interest. As discussed above, since the information is native to the system 10 it can be formatted accordingly to permit rapid access and retrieval using various metadata descriptor information. Thus, the system 10 is capable of searching an unlimited variety of resources from an unlimited number of subjects from an unlimited number of sources to locate particular documents of interest. Moreover, the various sources, such as external information systems 19, proprietary information systems 20, and native resources 21, and the information contained therein can be associated and accessed independently using techniques such as hyperlinking, content similarity, usage frequency, etc.

Upon completing a search operation, the system 10 may return a summary to the user via the interface 13 indicating the various “hits” in the related resource categories, such as textbooks, drug information, MEDLINE, Guidelines, journals, Cochrane, patient information, and the like. An exemplary summary result webpage 60 is shown in FIG. 3B. Retrieval hits (i.e., successful searches using the query terms) may be organized and displayed by, for example, resource type, to facilitate navigation. For example, a search performed on the query terms “leukotriene” and “asthma” may return 11 textbook hits, 31 drug information hits, 1,727 MEDLINE hits, 10 Guidelines hits, 24 journal hits, 6 Cochrane hits, and 2 patient information hits. The user can elect to view the results for a particular resource by selecting the heading 62a-g associated with that resource type. This navigation bar 62a-g preferably remains exposed in the interface throughout the user's query and subsequent retrieval of content information and advantageously makes it possible for the user to decide between alternative information types needed in the course of their decision making or learning without having to redo a search.

When a user selects a particular heading 62a-g, the user may be presented with the search results obtained for that resource type. For example, in FIG. 3C the user elects to view the search results obtained for the textbook resource type 62a. The results may be displayed as HTML links 70, 72, 74 that are organized by source, such as Scientific American™ Medicine (4 hits), Oxford Textbook of Medicine (2 hits), and Oski's Pediatric's: Principles and Practice (5 hits). When a user selects a source from the displayed search results, for example by selecting the associated HTML link 70, 72, 74, pointers to the subdocuments containing hits for the search query terms that can be retrieved may be displayed in the context of the inherent structure of the resource.

For example, hits in a subsection of a book chapter may be first presented in a hierarchical context within the book, i.e., in a table-of-contents (or ontology) structure of the book (such as is shown in FIG. 3D, described below). This ontology-based display allows the user to ignore hits that are in a subject area outside of the user's immediate interests or to consider the “outside” hits as a reference to differential diagnosis or alternatives to drugs, devices, or procedures. Additionally, internal links facilitate navigation within and among resources, and bibliographic references within each resource may be linked to the corresponding citations to facilitate navigation of full-text source articles. FIG. 3D illustrates this aspect of the invention, indicating particular subjects in a textbook resource where information relevant to the query is found. For example, in FIG. 3D, information relevant to the above query terms is found in the “Respiratory Medicine” section of the Scientific American™ Medicine textbook, particularly in the chapter relating to “Asthma.” Pathogenesis information 80a, specific etiologic forms and complications of asthma information 80b, and treatment information 80c are referenced, as well as Focal and Multifocal Lung Disease information 80d (Pulmonary Infiltrates). A user can access these topics by selecting the associated hypertext link 80a-d.

By selecting the various hypertext links 80a-d, the user can review various documents relating to the query. For example, FIG. 3E is an exemplary representation of a webpage 90 illustrating a document relating to “Leukotriene Inhibitors” that the user selected from the ontology-based display discussed above. Advantageously, the full text of the document can be displayed to the user so the user may review its contents, and various portions of the document may be hyperlinked 92 to additional documents, as is well known, to enable the user to review additional related documents in a simple fashion, for example, by selecting a desired hyperlink. Also, to facilitate identifying relevant portions of the document, the query terms may be highlighted 91 (or otherwise indicated) in the document.

Selecting a hyperlink 92 within the document causes a new document to be displayed to the user. In FIG. 3F, the displayed document is the endnote table for Chapter 2 of Scientific American™ Medicine, indicating numerous additional references containing related information. Advantageously, these references may also be accessible using the system and can be retrieved by selecting the particular associated hyperlink 100. In FIG. 3F, the reference “Effectiveness of the Leukotriene Receptor Antagonist Zafirlukast for Mild-to-moderate Asthma: A Randomized, Double-blind, Placebo-controlled Trial” can be retrieved by accessing MEDLINE. Since MEDLINE is a resource that is integrated with the system 10, the article can be accessed by the user by selecting the hyperlink 100. FIG. 3G shows an exemplary webpage 110 displaying the bibliographic citation, abstract, and hypertext link to the full-text, if available, retrieved from MEDLINE.

After reviewing the textbook references, the user may elect to review other reference types, such as journals which are likely to be available in full-text form. The user may select the associated header icon 62e to review a list of related journal articles. This is shown in FIG. 3H. Advantageously, the user can select from the available journal articles to review. For example, the user may elect to review a journal article 110 entitled “Randomised, Placebo Controlled Trial of Effect of a Leukotriene Receptor Antagonist, Montelukast, on Tapering Inhaled Corticosteroids in Asthmatic Patients” by selecting an associated checkbox 112 or otherwise selecting the journal article. Depending on whether or not the full text of the journal is available, the user may review an abstract (FIG. 3I) or the entire text of the article (FIG. 3J).

Similarly, a user may review additional reference types, such as drug information by selecting the associated header icon 62b to review a list of drug resource handbooks. This is shown in FIG. 3K. The user may elect to view a particular handbook entry, for example, by selecting an appropriate hypertext link 120. In FIG. 3K, for example, the Pediatric Dosage Handbook contains a reference to “Montelukast.” This reference can be reviewed by selecting the associated hypertext link 120, in which case the entry in the Handbook is displayed to the user (FIG. 3L).

A user may continue to review additional reference types, such as patient information, by selecting the associated header icon 62g to review a list of patient information studies and resources. Information such as National Institutes of Health fact papers, and Food and Drug Administration information, Centers for Disease Control information, etc., may be reviewed accordingly as described above. This is shown in FIG. 3M.

The technique of the invention can be compared with conventional systems that use only keyword searching to locate particular references of interest in response to a user query. A conventional keyword search may, depending on its query terms, return a similar number of hits as the present system; however, those hits are ordinarily returned in a linear list that is ordered by some arbitrary ranking, such as alphabetically, chronologically, or by descending order of how many relevant hits were registered in each document. Such a linear list typically requires the user to review each hit and decide whether the information is particularly relevant to the query. For example, in the case of the above search (i.e., “asthma” and “leukotriene”) a user using a conventional system to locate resources cannot know a priori that, for example, the initial hit relates to the immunological basis for allergy hypersensitivity and the fifteenth hit (or other number) relates to asthma treatment, without selecting each result and viewing its contents. The logical, ontology-based layout of hits in the present system's structured retrieval module addresses this problem by allowing a more efficient use of a user's time and attention. The invention takes advantage of the semantic relationships between document classes (i.e., textbooks, literature, etc.) and topics recognized by the user's intelligence and of the logarithmic reduction in the time required to scan hits in a hierarchical presentation, rather than a linear list.

Another aspect of the present invention that improves on conventional systems is that the system 10 can perform full-text searches on all or any single or combination of its available information. In the case of searches of all resources, this guarantees that all possibly relevant information is searched. In contrast with some conventional systems which search only the indexes of textbooks for possibly relevant information, the present invention generates a more tailored and more complete and therefore superior end result, that is tolerated well and more likely to satisfy the user's query and lead the user directly to current literature. Because not all information pertinent to a search will be represented in an (author-developed) index, conventional systems are limited in their ability to retrieve a large number of accurate and related resources. For example, in a search for “hypertension” performed on a conventional system, only the index of a given textbook might be searched, and results returned only if they are indexed in the back of the book as relating to hypertension. In contrast, using the present invention, a full-text search may locate a document, for example in the pharmacology chapter of a textbook, listing an important drug interaction leading to renal hypertension. Though this point may have been too minor to be indexed in the back of the textbook, it would have nevertheless been retrieved by the present system, and omitted or overlooked by most conventional systems.

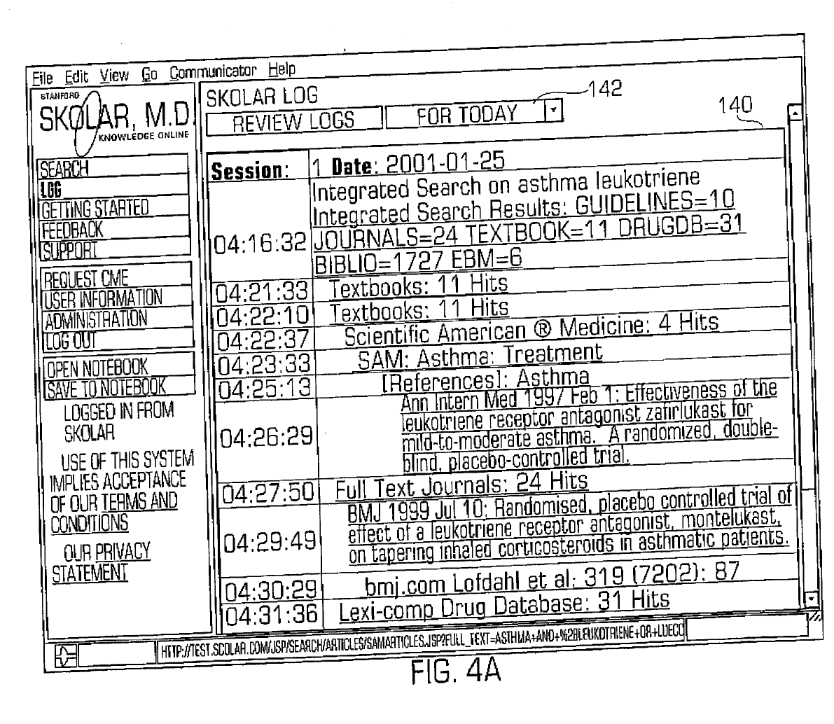

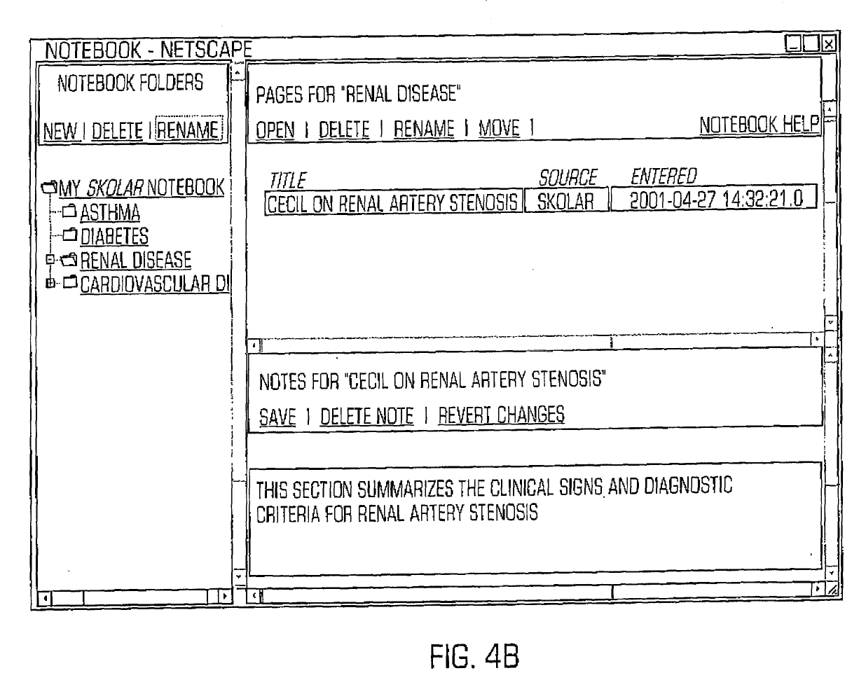

In addition to the query and retrieval interface 12, the system 10 may also include a log recording sub-system 22 which will be described below. Referring again to FIG. 1, the invention preferably maintains a user log 23 to capture the user's interaction with the system 10. The user log 23 preferably records each user's search activity including date and time of a search, query terms used in each search, documents reviewed, and links followed, among others. Each log entry in the user log 23 is preferably a hyperlink entry, which enables reconstruction of the search results and display screen that was displayed to the user via the user interface 13 (i.e., FIG. 3B) when the log entry was made. FIG. 4A is an exemplary representation of a log record 140 relating to the search described above indicating numerous entries showing the resource reviewed by the user. Additional logs can be reviewed by selecting the desired date (or other classification type), for example, by using a drop-down menu 142 to select the date.

Maintaining a user log 23, such as that described above, provides additional benefit to those who use the invention for research purposes. For example, to those users, the user log 23 provides a means of reviewing use patterns, detecting reasons for unsuccessful searches, assessing the value of particular content resources, and providing feedback to content providers. For other users, the user log 23 supports a review of their search experience.

To further illustrate the benefit of the user log 23, consider the following example. If a user has previously performed a search using the system as described above to investigate drug interventions for renal hypertension, for example, and the user were to forget the exact relationship between Drug A (any particular drug) and renal hypertension, the user need only check his or her user log 23 or notebook 24 to recreate the results of that query. In fact, the user can replicate their entire search on renal hypertension directly from the user log, as is described above. This feature also contributes to an educational module of the invention which will be described in more detail below.

In addition to the user log 23, the invention also supports a sophisticated notebook feature 24 which assists in actively managing information and organizing it in a user-oriented manner that optimizes knowledge creation. FIG. 4B is an exemplary representation of a notebook folder schema and a particular entry record relating to a search on “renal hypertension.” The notebook feature 24 is designed to give the user great flexibility in personalizing the system for their own particular use. It differs from the user log 23 in that it is a user-selected and annotated record of search activity. Its entries may be extracted from the user log 23 and organized under a user-definable hierarchy of category folders. For example, a user may wish to store all the information related to hypertension in a folder named “Hypertension.” Or alternatively, the user may wish to store information on renal hypertension in a folder named “Renal Diseases,” and information on cardiovascular hypertension in a folder named “Cardiovascular Diseases.” Using the notebook 24, the user may thus customize the record of search activity. Another feature of the notebook 24 allows a user to record comments on any object saved in the notebook. In addition, the user may wish to share notebook information with a user-defined group of people. This capability is accomplished using techniques that are well known in the art.

As described above, the system preferably includes an educational module 25 that permits a user to utilize the system for educational purposes as well as for informational purposes. For example, in the context of the medical field, the educational module 25 may permit the system to be used as a Continuing Medical Education tool. In embodiments of the invention tailored to other fields, the educational module 25 may permit different educational tools.

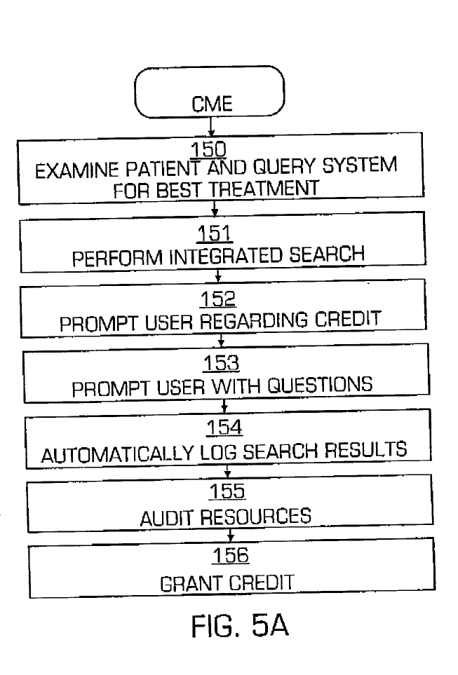

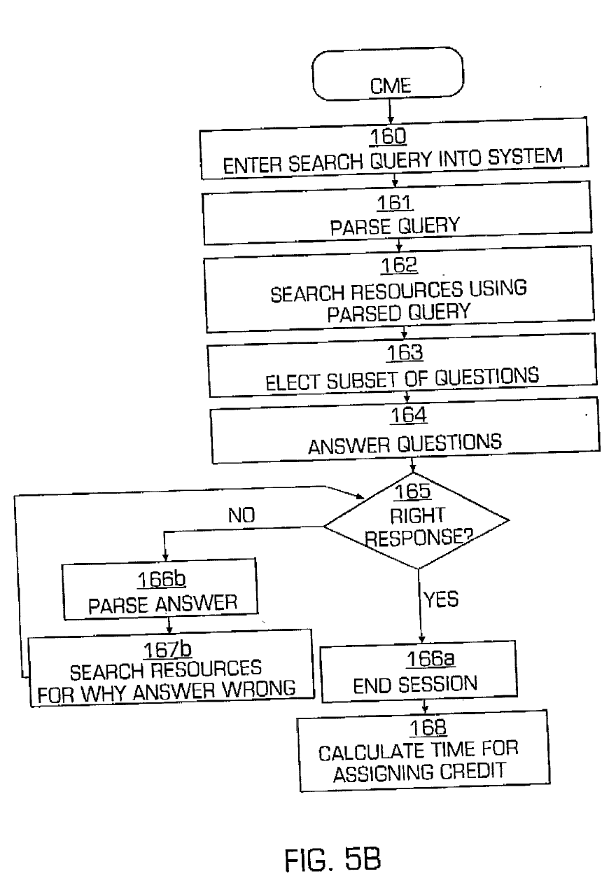

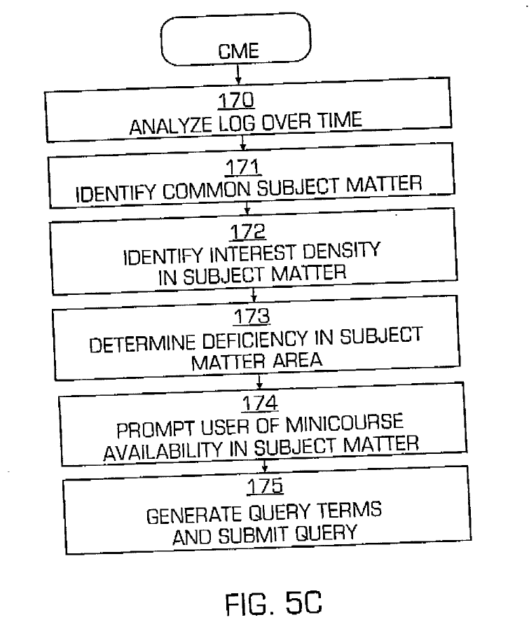

In accordance with the invention, the educational module 25 permits self-initiated learning in the context of, for example, real patient-related queries. FIG. 5A is a flowchart illustrating how a physician can use the invention to both treat a patient and earn educational credit as well. Such context-based learning, arising from real patient-derived questions, can be expected to provide the highest motivation for learning and retention by rewarding the use of high-quality information resources to better treat patients.

Preferably, there are multiple distinct strategies for carrying out CME (or other learning credit). Referring to FIG. 5A, in accordance with a first strategy, a doctor may approach a patient, for example by taking the patient's history, examining the patient, and considering a differential diagnosis as well as the treatment of choice for that patient. If a question comes to mind, he/she may query the system 10 to identify the answer to any provoked question, as described above. (Step 150). The doctor/user may log onto the system, as described above, and perform an integrated search (Step 151) searching resources such as books and journals, drug databases, guidelines, teaching modules, and other content.

When the doctor/user has completed learning, he/she may request CME credit (Step 152) from the system 10 (FIG. 1), and a number of questions may appear (for example, 4 questions may be presented) (Step 153). The first question may prompt the doctor to record, in natural language or other similar format, the question he/she has tried to answer by using the system 10. The next question may prompt the doctor/user whether the system 10 was successful in providing an answer to the doctor's question. The next question may prompt the doctor/user whether he/she has learned sufficiently to apply that answer directly to the clinical situation. If, for example, these prompts are answered positively, the student/doctor may enter the answer to the original question. Then, the system automatically logs the resources retrieved and reviewed by the doctor/user (Step 154), as discussed above using the educational module 25 (FIG. 1). The doctor/user can specify by using the log now modified to allow him/her to check the most important references he/she has encountered that allow him/her to transfer the newly learned knowledge to the patient without further search or research. These resources that were used to learn about a particular area of medicine may then be audited (Step 155), for example, manually by an expert in the area, or automatically by a machine, and if appropriate as the explanation for the clinical decision, the student/doctor/user will be granted CME credit (Step 156). Preferably, credit is in the Category 1 classification (others may be used) and is awarded in 15 minute (¼ unit) increments (others may be used) as dictated by the time stamps on the log entry. The student/doctor/user may be automatically notified, such as via e-mail, of the successful accumulation of CME credits. The student's/doctor's credits may be retrieved for verification for a particular number of years (for example, 6 years) after the last accumulation.

In another scheme for CME credit awarding, shown in FIG. 5B, a doctor may decide that he/she wants to study a particular issue of medicine and enters a natural language query into the system 10 (FIG. 1) as described above (Step 160). That question may be parsed by the system (Step 161), as described above, and the parsed terms may be used to search either the usual resources in which the answer might be found or if the doctor has already studied the subject, the parsed terms may be used to search a bank of stored questions that respond to, for example, descriptors such as ICD9 codes (a coding scheme for classifying various medical diseases), signs and symptoms and other laboratory or diagnostic markers of the disease (Step 162), or other lexical or concept-based matching methods. The physician may choose a fixed number of questions from the total number of stored questions (preferably less than 10 per query) (Step 163), and answer the questions by choice of the right alternative answer (i.e., multiple choice) (Step 164), however, essay-like responses or short-answer responses may also be used. If the right response is chosen, the session may be ended (Step 165). If the wrong choice is chosen, the answer may be parsed and used to search resources that explain why the answer choice is wrong (Step 166). This process can continue until the physician has made the right choice or the choices are exhausted (Step 167). Once the session is completed, the log may be used to calculate the time assignable for CME (Step 168), as described above. The process of notification of the physician and storage of the credit information may be accomplished automatically.

Yet another strategy for obtaining CME (or other) credit is more complex, and is shown in FIG. 5C. For example, the system 10 (FIG. 1) may analyze the user's log over a period of time (Step 170), such as several months. In areas where the student/doctor/user has shown concentrated or persistent interest, the questions and answers may be examined and the common subject area/matter is identified (Step 171). Then, a matrix of subjects that relate to, or are part of the identified subject may be examined for the density of the student's/doctor's/user's interest in these related subjects (Step 172). Whenever a hole/deficiency in utilization of the matrix is determined (Step 173), a mini course in medicine (or other topic) becomes possible. These intellectual holes are communicated to the student/doctor/user, by prompting whether a minicourse constructed specifically to fill that information gap in existing knowledge is desirable (Step 174). For instance, if a person has been reading about a number of subjects under the rubric of AIDS and had not read anything about its associated tumors or tuberculosis, those two subjects may be offered as minicourses in CME. Once the student/doctor/user accepts the challenge for the course, various search words (query terms) may appear (i.e., “AIDS” and “Tuberculosis” or “AIDS” and “Sarcomas”)(Step 175). After submitting the query, the process may proceed similar to that described in the other strategies discussed above.

Thus, physicians may query the system and retrieve relevant information from available resources to solve a specific patient problem. The results may be explored to identify the information needed to design a diagnostic or therapeutic plan for the patient. This activity is logged by the user log 23. The user (i.e., physician) can then choose, retrospectively, to request CME credits for this learning experience. To qualify for credit, the user may retrieve their personal log, identify a question asked relating to the search (for example, a detailed question relating to the patient's ailment), enter an answer learned by reviewing the retrieved information (for example, an essay-like response to the question), and identify which resources contributed to the user's learning. Answers may then be audited (manually or automatically) and educational credits may be granted accordingly.

The system's framework is designed to be flexible and configurable to meet end user or enterprise needs. To accomplish this, the system 10 utilizes a unique configuration technique referred to as “module harness” which enables the system 10 to be configured for different institutions or user groups using particular content sets. The system also facilitates “branding” in the sense that the information environment desired for individual enterprises will vary in terms of the important local content that should be added to the core content of the system, i.e. common textbooks, literature, and other resources. For example, local drug formularies, practice guidelines, procedures, policies, multimedia resources, and education modules all can be configured for different entities incorporating the present system. The application of the “harness” principle creates a mobile library that can be exported to any site the user wishes.

Referring again to FIG. 1, the system 10 may also include an Application Program Interface (API) 26 so that the system can be invoked from within another program, such as a local electronic medical record system, a client's Web-based program, or any site within the system itself including material that has been harnessed. This API 26 preferably supports either an interactive search interface for the remote program user, or the ability to pass a “canned” search query that returns a specified result context. Advantageously, the API 26 facilitates a more effective integration of the system's knowledge resources in local workflow management environments 27.

The underlying architecture of the system's knowledge management and access system is independent of the specific medical information (literature) resources used by the system. Thus, the invention has greater applicability than just the medical field. For example, applications may be developed for the system that enable the system to be utilized in the fields or engineering, architecture, business, law, education, humanities and sciences or advanced subjects in a number of academic and professional disciplines or corporate enterprise intranet information services design to facilitate the sharing of specialized expertise or learning opportunities.

What is claimed is:

1. A system for facilitating knowledge management, comprising:
a query and information retrieval system for accessing one or more databases and retrieving one or more documents from the databases that satisfy a particular query;
a search interface manager for mapping the query to a particular search syntax for a particular database; and
a log recording system for recording activity relating to a search and the use of the results of the search.

2. The system of claim 1, wherein the databases include local databases and remote databases, and wherein the remote databases include proprietary databases and non-proprietary databases.

3. The system of claim 2, wherein the documents stored in the databases include content elements including any of text, diagrams, images, audio clips, video clips, and direct collaborative links.

4. The system of claim 3, wherein the documents further include editorial elements that allow filtered and reviewed information to be contributed to the system.

5. The system of claim 1, wherein a document is represented by an object structure encoding content of the document, a description of the document, any relationship among additional documents, and structure of the document.

6. The system of claim 3, wherein the content is selectively marked with XML tags to indicate the internal context of the content and to indicate relationships among content sources.

7. The system of claim 6, wherein the XML tags are used for searching and retrieving the content.

8. The system of claim 6, wherein the XML-marked content that is retrieved in accordance with the query is adapted to be displayed on any type of output display using XSL.

9. The system of claim 3, wherein the content is selectively marked with HTML tags to indicate the internal context of the content and to indicate relationships among content sources.

10. The system of claim 1, wherein the databases store resources including any of text books, bibliographic resources and journals, that are searchable by the query and information retrieval system.

11. The system of claim 1, wherein the system is customized for the medical profession such that the databases include searchable resources including any of text books, bibliographic resources, journals, drug databases, national clinical guidelines, evidence-based medicine resources, patient information, drug formularies, policy information, procedure information, devise information, and educational information.

12. The system of claim 1, wherein the system is customizable for any particular field of endeavor.

13. The system of claim 2, wherein an external interface module permits the interfacing of the system with a particular external server hosting a respective non-proprietary database.

14. The system of claim 13, wherein the interfacing is provided via the Internet.

15. The system of claim 13, wherein the interfacing is provided using the HTTP protocol.

16. The system of claim 2, wherein a proprietary interface module permits the interfacing of the system with a particular proprietary information system associated with a respective proprietary database.

17. The system of claim 16, wherein an API interface module translates general requests from the proprietary interface module to requests that are recognizable by the proprietary information system for accessing the proprietary database and for performing a search operation in accordance with the query to retrieve information from the proprietary database satisfying the particular query.

18. The system of claim 16, wherein an API interface module translates general requests from a Web-based information source to requests that are recognizable by the proprietary information system for accessing the proprietary database and for performing a search operation in accordance with the query to retrieve information from the proprietary database satisfying the particular query.

19. The system of claim 2, wherein the local databases store resource information native to the system, and wherein such resources are stored using structured metadata descriptors to either improve retrieval performance, facilitate an ontology-based indexing scheme, or allow searching of non-text content.

20. The system of claim 19, wherein the non-text content includes any of images, streaming audio clips, and streaming video clips.

21. The system of claim 19, wherein a native search module permits the searching of one or more of the local databases to retrieve information satisfying the particular query.

22. The system of claim 21, wherein the information is retrieved from any source of medical record keeping.

23. The system of claim 19, wherein the metadata descriptor structure includes a source portion for indicating a resource to which a particular document belongs, an object ID portion for tracking and indicating an identifier for a particular document, a document type portion for indicating a type of document, one or more field attributes for indicating information about a particular document, and a content object portion for indicating a type of object to associate with a particular document.

24. The system of claim 23, wherein in response to a query request including one or more query terms, a search operation is performed in accordance with the query terms by referencing an object index file to locate a respective object ID corresponding to one or more documents containing at least one of the query terms.

25. The system of claim 1, wherein a search operation is performed on each database in parallel.

26. The system of claim 1, wherein the retrieved documents are presented in accordance with a dynamic ontological structure utilizing semantic relationships among document classes.

27. The system of claim 26, wherein the retrieved documents are dynamically linked permitting rapid review of those documents most relevant to the particular query.

28. The system of claim 1, wherein the log recording system comprises a user log which permits a user to assess the value of particular content resources, and a notebook which assists in actively managing and organizing retrieved information.

29. The system of claim 28, wherein the log recording system generates one or more log entries in the user log indicating information relating to the search.

30. The system of claim 29, wherein each log entry is hyperlinked permitting reconstruction of the associated search by selecting an appropriate log entry.

31. The system of claim 28, wherein the notebook permits the user to record comments relating to the search and to share notebook information with additional users.

32. The system of claim 1, further comprising an educational module for permitting self-initiated learning related to subject matter of the query.

33. The system of claim 32, wherein the educational module is customized for a particular field of endeavor.

34. The system of claim 32, wherein the educational module permits Continued Medical Education learning.

35. The system of claim 34, wherein one or more questions are presented that are related to subject matter of the retrieved documents, and wherein responses to those questions are submitted, and in accordance with an audit of the responses, educational credit is awarded if appropriate.

36. The system of claim 1, further comprising an API interface permitting the system to be invoked from an executing application.

37. The system of claim 1, wherein non-core resources are accepted via an electronic harness and searched in common with other core resources to provide an integrated search result in accordance with the query.

38. The system of claim 1, wherein the system is integrated into an electronic medical record (EMR).

39. A system for facilitating knowledge management, comprising:
a query and information retrieval system for accessing one or more local or remote databases and retrieving one or more documents from the databases that satisfy a particular query, the query and information retrieval system including:
an external interface module for permitting the interfacing of the system with a particular external server hosting a respective non-proprietary remote database;
a proprietary interface module for permitting the interfacing of the system with a particular proprietary information system associated with a respective proprietary remote database; and
a native search module for permitting the searching of one or more of the local databases;
a search interface manager for mapping the query to a particular search syntax for a particular database; and
a log recording system including a user log permitting the assessing of the value of particular content resources, and a notebook for assisting in actively managing and organizing retrieved information.

40. The system of claim 39, wherein the documents stored in the databases include content elements including any of text, diagrams, images, audio clips, video clips, and direct collaborative links.

41. The system of claim 39, wherein a document is represented by an object structure encoding content of the document, a description of the document, any relationship among additional documents, and structure of the document.

42. The system of claim 40, wherein the content is selectively marked with XML tags to indicate the internal context of the content and to indicate relationships among content sources.

43. The system of claim 42, wherein the XML tags are used for searching and retrieving the content.

44. The system of claim 42, wherein the XML-marked content that is retrieved in accordance with the query is adapted to be displayed on any type of output display using XSL.

45. The system of claim 39, wherein the databases store resources including any of text books, bibliographic resources and journals, that are searchable by the query and information retrieval system.

46. The system of claim 39, wherein an API interface module translates general requests from the proprietary interface module to requests that are recognizable by the proprietary information system for accessing the proprietary database and for performing a search operation in accordance with the query to retrieve information from the proprietary database satisfying the particular query.

47. The system of claim 39, wherein information native to the system is stored using structured metadata descriptors to either improve retrieval performance, facilitate an ontology-based indexing scheme, or allow searching of non-text content.

48. The system of claim 47, wherein the non-text content includes any of images, streaming audio clips, and streaming video clips.

49. The system of claim 47, wherein the metadata descriptor structure includes a source portion for indicating a resource to which a particular document belongs, an object ID portion for tracking and indicating an identifier for a particular document, a document type portion for indicating a type of document, one or more field attributes for indicating information about a particular document, and a content object portion for indicating a type of object to associate with a particular document.

50. The system of claim 39, wherein in response to a query request including one or more query terms, a search operation is performed in accordance with the query terms by referencing an object index file to locate a respective object ID corresponding to one or more documents containing at least one of the query terms.

51. The system of claim 39, wherein a search operation is performed on each database in parallel.

52. The system of claim 39, wherein the retrieved documents are presented in accordance with a dynamic ontological structure utilizing semantic relationships among document classes.

53. The system of claim 52, wherein the retrieved documents are dynamically linked permitting rapid review of those documents most relevant to the particular query.

54. The system of claim 39, wherein the log recording system generates one or more log entries in the user log indicating information relating to the utilization of the results of the search.

55. The system of claim 54, wherein each log entry is hyperlinked permitting reconstruction of the associated search by selecting an appropriate log entry.

56. The system of claim 39, wherein the notebook permits the user to record comments relating to the search and to share notebook information with additional users.

57. The system of claim 56, wherein the comments include any of pages of information, figures, tables, images and access to video or audio segments.

58. The system of claim 39, further comprising an educational module for permitting self-initiated and accredited learning related to subject matter of the query.

59. The system of claim 58, wherein the educational module permits Continued Medical Education learning.

60. The system of claim 58, wherein one or more questions are presented that are related to subject matter of the retrieved documents, and wherein responses to those questions are submitted, and in accordance with an audit of the responses, educational credit is awarded if appropriate.

61. The system of claim 39, further comprising an API interface permitting the system to be invoked from an executing application.

62. A system for facilitating knowledge management, comprising:
a query and information retrieval system for accessing one or more local or remote databases and retrieving one or more documents from the databases that satisfy a particular query, the query and information retrieval system including:
an external interface module for permitting the interfacing of the system with a particular external server hosting a respective non-proprietary remote database;
a proprietary interface module for permitting the interfacing of the system with a particular proprietary information system associated with a respective proprietary remote database; and
a native search module for permitting the searching of one or more of the local databases;
a search interface manager for mapping the query to a particular search syntax for a particular database;
a log recording system including a user log permitting the assessing of the value of particular content resources, and a notebook for assisting in actively managing and organizing retrieved information;
an educational module for permitting self-initiated learning related to subject matter of the query; and
an API interface permitting the system to be invoked from an executing application.

63. The system of claim 62, wherein the documents stored in the databases include content elements including any of text, diagrams, images, audio clips, video clips, and direct collaborative links.

64. The system of claim 62, wherein a document is represented by an object structure encoding content of the document, a description of the document, any relationship among additional documents, and structure of the document.

65. The system of claim 63, wherein the content is selectively marked with XML tags to indicate the internal context of the content and to indicate relationships among content sources.

66. The system of claim 65, wherein the XML tags are used for searching and retrieving the content.

67. The system of claim 65, wherein the XML-marked content that is retrieved in accordance with the query is adapted to be displayed on any type of output display using XSL.

68. The system of claim 62, wherein the databases store resources including any of text books, bibliographic resources and journals, that are searchable by the query and information retrieval system.

69. The system of claim 62, wherein an API interface module translates general requests from the proprietary interface module to requests that are recognizable by the proprietary information system for accessing the proprietary database and for performing a search operation in accordance with the query to retrieve information from the proprietary database satisfying the particular query.

70. The system of claim 62, wherein information native to the system is stored using structured metadata descriptors to improve retrieval performance and to facilitate an ontology-based indexing scheme.

71. The system of claim 70, wherein the metadata descriptor structure includes a source portion for indicating a resource to which a particular document belongs, an object ID portion for tracking and indicating an identifier for a particular document, a document type portion for indicating a type of document, one or more field attributes for indicating information about a particular document, and a content object portion for indicating a type of object to associate with a particular document.

72. The system of claim 62, wherein in response to a query request including one or more query terms, a search operation is performed in accordance with the query terms by referencing an object index file to locate a respective object ID corresponding to one or more documents containing at least one of the query terms.

73. The system of claim 62, wherein a search operation is performed on each database in parallel.

74. The system of claim 62, wherein the retrieved documents are presented in accordance with a dynamic ontological structure utilizing semantic relationships among document classes.

75. The system of claim 74, wherein the retrieved documents are dynamically linked permitting rapid review of those documents most relevant to the particular query.

76. The system of claim 62, wherein the log recording system generates one or more log entries in the user log indicating information relating to the search.

77. The system of claim 76, wherein each log entry is hyperlinked permitting reconstruction of the associated search by selecting an appropriate log entry.

78. The system of claim 62, wherein the notebook permits the user to record comments relating to the search and to share notebook information with additional users.

79. The system of claim 62, wherein the educational module permits Continued Medical Education learning.

80. The system of claim 62, wherein one or more questions are presented that are related to subject matter of the retrieved documents, and wherein responses to those questions are submitted, and in accordance with an audit of the responses, educational credit is awarded if appropriate.

81. A system for facilitating knowledge management, comprising:
means for accessing one or more local or remote databases and retrieving one or more documents from the databases that satisfy a particular query;
means for interfacing with a particular external server hosting a respective non-proprietary remote database;
means for interfacing with a particular proprietary information system associated with a
respective proprietary remote database;
means for searching one or more of the local databases;
means for mapping the query to a particular search syntax for a particular database;
means for assessing of the value of particular content resources and for assisting in actively managing and organizing retrieved information; and
means for permitting self-initiated learning related to subject matter of the query.

82. A metadata descriptor structure for facilitating a structured ontology-based indexing scheme within a database including one or more documents, comprising:
a source portion for indicating a resource to which a particular document belongs;
an object ID portion for tracking and indicating an identifier for a particular document;
a document type portion for indicating a type of document;
one or more field attributes for indicating information about a particular document; and
a content object portion for indicating a type of object to associate with a particular document.

83. A method for enabling self-initiated learning, comprising the steps of:
identifying a particular problem to be solved;
performing an integrated search for a solution to the problem by generating a query related to the problem and submitting the query using a query and information retrieval system which permits accessing one or more databases and retrieving one or more documents from the databases that satisfy the query such that a search interface manager maps the query into a particular search syntax for a particular database;
reviewing the resulting information to identify a solution to the problem; and
requesting educational credit for the experience by responding to one or more questions that are related to the retrieved information.

84. A method for enabling self-initiated learning by an individual, comprising the steps of:
performing an integrated search using a system for facilitating knowledge management by entering a query relating to a particular issue of interest;
parsing the query into a first set of one or more related query terms and performing a search of a database of one or more pregenerated questions that relate to the issue of interest;
electing one or more of the questions from the database for generating a respective response to each question based on the knowledge gleaned from performing the integrated search;
for each response that is incorrect, parsing the answer into a second set of one or more related query terms and performing a search of resources in which answers to the respective question can be determined; and
determining an appropriate amount of credit relating to the query that is to be assigned to the individual.

85. A method for enabling self-initiated learning by an individual, comprising the steps of:
analyzing research patterns of the individual over a predetermined period of time;
identifying common subject matter relating to the research pattern of the individual;
referencing a matrix of subjects that relate to or are part of the identified subject matter to determine a density factor of the interest of the individual in the related subjects;
determining a deficiency in the research pattern of the individual, the deficiency relating to a particular subject area;
prompting the individual of the availability of an associated mini-course relating to the subject area;
if the individual accepts the mini-course, automatically generating one or more query terms relating to the subject area;
performing an integrated search using a system for facilitating knowledge management for resources relating to the query terms; and
reviewing the resources to supplement the knowledge of the individual in the subject area.
